(19) United States
(12) Patent Application Publication
(10) Pub. No.: US 2005/0148697 A1
(43) Pub. Date: Jul. 7, 2005

(54) Composite element comprising (I) materials made from wood, wood-like materials and/or wood replacement materials and (II) thermoplastic polyurethane

(75) Inventors: Marcus Leberfinger, Georgsmarienhuette (DE); Hans-Werner Kampsen, Damme (DE); Gunter Scholz, Lemforde (DE); Rudiger Krech, Diepholz (DE); Johann-Diedrich Brand, Lemforde (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/510,231

(22) PCT Filed: Apr. 22, 2003
(86) PCT No.: PCT/EP03/04128

(30) Foreign Application Priority Data
Apr. 26, 2002 (DE) 102 18 848.3

(51) Int. Cl. C08L 1/00

(52) U.S. Cl. 524/13

(57) ABSTRACT

A composite element in the furniture sector, preferably furniture doors and furniture carcasses, comprises (i) laminated or unlaminated materials based on wood, wood boards or particle boards and/or wood-like materials, preferably based on wood boards or particle boards, and (ii) thermoplastic polyurethane. Processes for the production of these composite elements and in particular furniture carcasses or doors comprising the novel composite elements are furthermore described. In particular, film hinges, preferably for furniture construction, for example for furniture carcasses, drawers or door frames, in particular for furniture carcasses based on thermoplastic polyurethanes are described.

The present invention relates to a composite element preferably in the furniture sector, preferably furniture doors and furniture carcasses, comprising (i) laminated or unlaminated materials based on wood, wood boards or particle boards and/or wood-like materials, preferably based on wood boards or particle boards, and (ii) thermoplastic polyurethane. The present invention furthermore relates to processes for the production of these composite elements and in particular furniture carcasses or doors comprising the novel composite elements. In particular, the present invention relates to film hinges, preferably for furniture construction, for example for furniture carcasses, drawers or door frames, in particular for furniture carcasses based on thermoplastic polyurethanes.

Composite materials comprising wood and plastic are generally known and are increasingly used owing to the combination of the advantageous properties of the two materials. Crosslinked polyurethanes are also generally known, for example as adhesives or coatings for timbers. In addition to timbers or particle boards coated with plastics, e.g. plastics films, composite materials in which the plastic is present as a functional element owing to its elastic properties are also increasingly being used. Thus, DE-A 198 49 504 describes the production of furniture carcasses, in which a thermoplastic which is processed by injection molding acts as a film hinge. This method starts from the carcass sides which can be joined together by the film folding method and are formed from a board having V-grooves cut into it. The V-grooves extend along the fold lines along which a film hinge is provided, in each case in the apex region of the V-grooves. In this way, a furniture carcass can be folded together, in particular, from four board parts connected to one another via three film hinges. In order to achieve better technical possibilities and latitudes for aesthetic design in the formation of the carcass edges, the film hinge is formed by a plastics material which is injected into grooves provided on the starting board and adheres to and remains on the carcass sides swiveled together.

It is an object of the present invention to provide a suitable plastic for the formation of the film hinge according to DE-A 198 49 504.

We have found that this object is achieved by using thermoplastic polyurethane, also referred to below as TPU. Compared with the plastics customary for the wood industry, e.g. PU resins, TPU exhibits in particular high elongations at break, tensile strengths and tear propagation strengths and low abrasion. In particular, aliphatic TPU has been found to be very useful since on the one hand it has excellent light stability, which is essential for carcasses with a long service life, and, on the other hand, it has very good flowabilities. These good flowabilities are necessary for realizing the long flow paths for the formation of film hinges by injection molding and for achieving the penetration of the TPU melt into the pores of the wood or of the particle board, in order thus to obtain good adhesion between the film hinge and the wood. Polyether-TPU and in particular aliphatic polyether-TPU are moreover stable to microbes. This proves to be particularly important when such composite elements, e.g. furniture carcasses, are used in wet rooms, e.g. bathroom and kitchen.

In the novel composite elements, the thermoplastic polyurethane (ii), which is preferably applied onto and/or into the material (i) by means of injection molding, is preferably in adhesive contact with the wood material (i). As described at the outset, the present invention relates to all possible designs of composite elements based on (i) wood materials and (ii) thermoplastic polyurethanes and is not limited only to film hinges. However, furniture or furniture elements which include the novel composite elements are particularly preferred since the advantages according to the invention are displayed in particular precisely in these intended uses. Preferred embodiments are, for example, furniture carcasses or doors, for example furniture doors, which comprise the TPU for example as a veneer, i.e. e.g. as a laminate, and/or as a film hinge. Particularly preferred are film hinges, for example those described in DE-A 198 49 504, preferably for furniture construction, for example for furniture carcasses, drawers or door frames, in particular for furniture carcasses, based on thermoplastic polyurethanes. The production and the use of these preferred film hinges are described in DE 198 49 504. Since the entire content of DE 198 49 504 is concerned with the production and the use of these film hinges, the entire content of DE 198 49 504 is hereby expressly incorporated by reference. The film hinges, in particular for furniture, usually comprise plastics material, in the present case TPU, which is applied in a board, preferably in the groove of a board as a starting mold, along the corner edge to be formed, preferably by means of injection molding. A V-shaped section can then be cut out, for example milled or sawn, from the subsequent inside of the starting mold, up to the film hinge or into the film hinge. Accordingly, the film hinge forms the axis of rotation about which the side parts of the starting mold can be folded toward one another.

Generally known materials which are used in particular in the furniture industry can be employed as material (i) based on wood, wood-like materials, preferably wood board or particle board, or wood substitute materials. For example, solid timbers, wood boards or pressboards are suitable. The wood materials are preferably based predominantly on wood, but other materials, e.g. adhesives, crosslinking agents and filling materials, may also be present in the material (i). The materials (i) preferably have a wood content greater than 30, particularly preferably from 40 to 100, % by weight. The wood materials (i) may be uncoated or coated with conventional materials.

Thermoplastic polyurethanes (ii), also referred to below as TPU, and processes for their preparation are generally known and widely described. TPU are semicrystalline materials which belong to the class consisting of the thermoplastic elastomers. They have, inter alia, good strengths, abrasion properties, tear propagation strengths and resistance to chemicals and can be produced in virtually any desired hardness by suitable raw material composition. In addition, TPU have the advantage of economical production, for example by the belt or reaction extruder process, which can be carried out continuously or batchwise, and simple thermoplastic processing.

Usually, the preparation is carried out by reacting (a) diisocyanates, preferably aliphatic diisocyanates in the present case, with (b) compounds reactive toward isocyanates and having a molecular weight of from 500 to 8 000 g/mol, in the presence or absence of (c) chain extenders having a molecular weight of from 60 to 499 g/mol, (d) catalysts and/or (e) conventional assistants.

To establish the hardness of the TPUs, the components (b) and (c) can be varied within relatively wide molar ratios. Molar ratios of from 1:0.5 to 1:8, in particular from 1:1 to 1:4, for component (b) to the total amount of chain extenders (c) to be used have proven useful, the hardness of the TPUs increasing with increasing content of (c). The reaction for the preparation of the TPU can be carried out at an index of from 0.8:1 to 1.2:1, preferably from 0.9:1 to 1:1. The index is defined by the ratio of all the isocyanate groups of component (a) which are used in the reaction to the groups reactive toward isocyanates, i.e. the active hydrogen atoms, of components (b) and, if required, (c) and, if required, monofunctional components reactive toward isocyanates, as chain terminators, e.g. monoalcohols. The thermoplastic polyurethanes are usually prepared in the one-shot or prepolymer process on a belt line or in a reaction extruder. Here, the components (a), (b) and (c) and, if required, chain terminators reacted are all combined together or combined in a specific sequence and reacted. In the reaction extruder process, the components (a) to (c), and, if required, chain terminators, (d) and/or (e) are introduced individually or as a mixture into the extruder, or reacted, for example, at from 100 to 250° C., preferably from 140 to 220° C., and the TPU obtained is extruded, cooled and granulated. The processing of the TPU (ii), which are usually present in the form of granules, with the material (i) to give the novel composite elements is effected by the injection molding process known to a person skilled in the art. Here, the cavity is formed by the groove itself (square or rectangular) which is cut into the wood material or, usually, particle board material or into the wood substitute material for the formation of the film hinge. The region usually referred to in the injection molding shop as the gate is formed by a sprue beginning from the inside of the wood material or particle board material. Regarding the exact description of this injection molding process and of the subsequent finishing to produce the final film hinge, as well as of the final assembly of the carcass, reference is made here to DE 198 49 504 (columns 2 to 6; FIG. 1 to 10). The shot weight in this specific process is usually from 5 to 50 g, so that a screw diameter of from 12 to 23 mm is advisable. The processing temperatures are usually from 130 to 230° C. By specifically establishing a low molecular weight, on the one hand via the index and/or on the other hand through the use of chain terminators, injection molding temperatures of from 150 to 200° C., preferably from 130 to 180° C., can be realized. The components (a), (b), (c) and, if required, (e) and/or (f) usually used in the preparation of the TPUs are to be described below by way of example:
a) Isocyanates which may be used, usually diisocyanates, are aliphatic, cycloaliphatic, araliphatic and/or aromatic diisocyanates. Specific examples are the following aromatic isocyanates: tolylene 2,4-diisocyanate, mixtures of tolylene 2,4- and 2,6-diisocyanate, diphenylmethane 4,4′-, 2,4′- and/or 2,2′-diisocyanate, mixtures of diphenylmethane 2,4′- and 4,4′-diisocyanate, urethane-modified liquid diphenylmethane 4,4′- and/or 2,4-diisocyanates, 4,4′-diisocyanato-1,2-diphenylethane and naphthylene 1,5-diisocyanate. The TPUs of the novel composite elements are preferably based on aliphatic isocyanates. Aliphatic diisocyanates (a) used are conventional aliphatic and/or cycloaliphatic diisocyanates, for example tri-, tetra-, penta-, hexa-, hepta- and/or octamethylene diisocyanate, 2-methylpentamethylene 1,5-diisocyanate, 2-ethylbutylene 1,4-diisocyanate, 1-isocyanato-3,3,5-trimethyl-5-isocyanatom-ethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, dicyclohexylmethane 4,4′-, 2,4′- and/or 2,2′-diisocyanate. Hexamethylene 1,6-diisocyanate (hexamethylene diisocyanate, HDI) is preferably used as aliphatic diisocyanate (a).
b) Generally known polyhydroxy compounds having a molecular weight of from 500 to 8 000, preferably from 600 to 6 000, in particular from 800 to 4 000, g/mol and preferably having an average functionality of from 1.8 to 2.6, preferably from 1.9 to 2.2, in particular 2, can be used as compounds (b) reactive toward isocyanates, for example polyesterols, polyetherols and/or polycarbonatediols.

Polytetrahydrofuran having a molecular weight of from 750 to 5 000, preferably from 750 to 2 500, particularly preferably 2 000, g/mol are preferably used as (b). Suitable polyetherpolyols are generally prepared by known processes, for example by anionic polymerization with alkali metal hydroxides or alkali metal alcoholates as catalysts and with addition of at least one initiator which contains 2 to 8, preferably 2 to 6, in particular 2, reactive hydrogen atoms bonded per molecule, or by cationic polymerization with Lewis acids or multimetal cyanide compounds as catalysts, from one or more alkylene oxides having 2 to 4 carbon atoms in the alkylene radical. Suitable alkylene oxides are, for example, tetrahydrofuran, 1,2- and 2,3-butylene oxide, styrene oxide and preferably ethylene oxide and 1,2-propylene oxide or tetrahydrofuran. The alkylene oxides can be used individually, alternately in succession or as mixtures. Examples of suitable initiator molecules are water, organic dicarboxylic acids, such as succinic acid, adipic acid, phthalic acid and terephthalic acid, alkanolamines, polyhydric alcohols, in particular alcohols which are dihydric and/or have a higher functionality, such as ethanediol, 1,2- and 1,3-propanediol, diethylene glycol, dipropylene glycol, 1,4-butanediol, 1,6-hexanediol, glycerol, trimethylolpropane, pentaerythritol and sucrose.
Suitable polyesterpolyols can be prepared, for example, from organic dicarboxylic acids of 2 to 12 carbon atoms, preferably aliphatic dicarboxylic acids of 4 to 6 carbon atoms, and polyhydric alcohols, preferably diols, of 2 to 12, preferably 2 to 6, carbon atoms. Examples of suitable dicarboxylic acids are succinic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids may be used either individually or as a mixture with one another. Instead of the free dicarboxylic acids, it is also possible to use the corresponding dicarboxylic acid derivatives, e.g. dicarboxylic esters of alcohols of 1 to 4 carbon atoms or dicarboxylic anhydrides. Examples of dihydric and polyhydric alcohols, in particular diols, are ethanediol, diethylene glycol, 1,2- and 1,3-propanediol, dipropylene glycol, 1,4-butanediol, 1,5-pentanediol, 1,6-hexanediol, 1,10-decanediol, glycerol and trimethylolpropane.
c) Chain extenders (c) which may be used are generally known compounds, for example diamines and/or alkanediols having 2 to 10 carbon atoms in the alkylene radical, in particular ethylene glycol and/or 1,4-butanediol and/or hexanediol and/or di- and/or trioxyalkylene glycols having 3 to 8 carbon atoms in the oxyalkylene radical, preferably corresponding oligo- or polyoxypropylene glycols, it also being possible to use mixtures of the chain extenders. Other chain extenders which may be used are 1,4-bis(hydroxymethyl)benzene (1,4-BHMB), 1,4-bis(hydroxyethyl)benzene (1,4-BHEB) or 1,4-bis(2-hydroxyethoxy)benzene (1,4-HQEE). Preferably used chain extenders are ethylene glycol, butanediol and/or hexanediol.
d) Suitable catalysts which in particular accelerate the reaction between the NCO groups of the diisocyanates (a) and the hydroxyl groups of components (b) and (c) are the conventional tertiary amines known from the prior art, e.g. triethylamine, dimethylcyclohexylamine, N-methylmorpholine, N,N′-dimethylpiperazine, 2-(dimethylaminoethoxy)ethanol, diazabicyclo[2.2.2]octane and the like, and in particular organic metal compounds, such as titanic esters, iron compounds, e.g. iron(III) acetylacetonate, tin compounds, e.g. tin diacetate, tin dioctanoate, tin dilaurate or the dialkyltin salts of aliphatic carboxylic acids, such as dibutyltin diacetate, dibutyltin dilaurate or the like. The catalysts are usually used in amounts of from 0.0001 to 0.1 part by weight per 100 parts by weight of polyhydroxy compound (b).
e) In addition to catalysts, conventional assistants (e) may also be added to the components (a) to (d). Examples are surface-active substances, glass fibers, flameproofing agents, nucleating agents, lubricants and mold release agents, dyes and pigments, inhibitors, hydrolysis, light, heat or discoloration stabilizers, antioxidants, compositions for protection from microbial degradation, inorganic and/or organic fillers, reinforcing agents and plasticizers. Other examples are additives which, specifically in this invention, lead to an improvement in the adhesion between TPU and wood, particle board or wood substitute materials. Such adhesion promoters may be, for example, isocyanate-containing additives.
Said assistants or additives can be added to the TPU directly during the synthesis or not until the thermoplastic processing, and may be added as such or after incorporation in a carrier, e.g. TPU, as masterbatches.

In addition to said raw materials (a) to (e), chain terminators having a molecular weight of from 46 to 499 may also be used. Such chain terminators are compounds which have only one functional group reactive toward isocyanates, e.g. monoalcohols. The flow behavior can be established in a controlled manner by means of such chain terminators.

Detailed information about the abovementioned assistants and additives are to be found in the technical literature. All molecular weights stated in this document have the unit [g/mol] and are number average molecular weights.

The advantages according to the invention are to be described with reference to the following examples.

### EXAMPLE 1 BASED ON HDI

1 000 parts by weight of PTHF 2000 (polytetrahydrofuran; molecular weight 2 000; OH number=56.7) were combined, at 80° C., with 83 parts by weight of butanediol, 4 parts by weight of n-octanol (chain terminator) and 0.5% each of Tinuvin® 328, Tinuvin® 622 LD and Irganox® 1010 and 100 ppm of SDO in a vessel while stirring. 240 parts by weight of hexamethylene diisocyanate (HDI) were then added all at once at 80° C. with vigorous stirring. Once the reaction mixture had reached 110° C., the material was poured into a dish and the reaction completed at 80° C. for 15 hours in an oven. The completely reacted slab was then granulated.

### EXAMPLE 2 BASED ON MDI

1 000 parts by weight of PTHF 1000 (polytetrahydrofuran; molecular weight 1 000; OH number=112.1) were combined, at 80° C, with 143 parts by weight of butanediol, 2 parts by weight of n-octanol (chain terminator) and 0.5% each of Tinuvin® 328, Tinuvin® 622 LD and Irganox® 1010 and 5 ppm of SDO in a vessel while stirring. 650 parts by weight of diphenylmethane 4,4′-diisocyanate (MDI) were then added all at once at 80° C. with vigorous stirring. Once the reaction mixture had reached 110° C., the material was poured into a dish and the reaction completed at 80° C. for 15 hours in an oven. The completely reacted slab was then granulated.

The thermoplastic processing of the granules was carried out on an injection molding line from Boy. The processing temperatures were 160° C. The melt was injected directly into the particle board. Regarding the process, reference may be made to DE 19849504. Both in example 1 and in example 2, the film hinge obtained shows high to very high adhesion to the particle board. On folding together to give the carcass, the film hinge is not detached.

1. A composite element comprising
(i) a material comprising wood, wood-like materials and/or wood substitute materials and
(ii) a thermoplastic polyurethane,
wherein the thermoplastic polyurethane (ii) is obtained by reacting
(a) hexamethylene diisocyanate with
(b) compounds reactive toward isocyanates and having a molecular weight of from 500 to 8 000 g/mol and
(c) chain extenders having a molecular weight of from 60 to 499 g/mol and if required, optionally as chain terminators, monofunctional compounds reactive toward isocyanates,
(d) catalysts and/or
(e) conventional assistants.

2. The composite element as claimed in claim 1, wherein said material (i) is a wood board or particle board.

3. The composite element as claimed in claim 1, wherein said thermoplastic polyurethane (ii) is comprised in a film or a film hinge.

4. The composite element as claimed in claim 1, wherein the thermoplastic polyurethane (ii) is applied onto and/or into the material (i) by injection molding.

5. A furniture carcass comprising the composite element as claimed in claim 1.

6. A door comprising the composite element as claimed in claim 1.

7. A film hinge comprising a thermoplastic polyurethane.

8. A process for the production of the composite element as claimed in claim 1, the process comprising:
applying the thermoplastic polyurethane (ii) by injection molding onto and/or into the material comprising wood, wood-like material and/or wood substitute material.
